(19) United States
(12) Patent Application Publication
(10) Pub. No.: US 2012/0299317 A1
(43) Pub. Date: Nov. 29, 2012

(54) BIODEGRADABLE PET WASTE COLLECTION DEVICE

(75) Inventor: Mary McKone, Colorado Springs, CO (US)

(73) Assignee: Yappy Products LLC, Colorado Springs, CO (US)

(21) Appl. No.: 13/479,628

(22) Filed: May 24, 2012

Related U.S. Application Data
(60) Provisional application No. 61/491,011, filed on May 27, 2011.

(51) Int. Cl. A01K 29/00

(52) U.S. Cl. 294/1.3

(57) ABSTRACT

An apparatus for collecting and disposing pet waste that includes a biodegradable plastic bag and either one or two built-in disposable collection aids. The user grasps the lower closed end of the bag while also grabbing the built-in disposable collection aid. The bag is then inverted over the user's hand and forearm, providing protection from the pet waste and exposing the built-in collection aid. The collection aid's leading edge acts as a scoop and facilitates scooping up the pet waste. The bag is then inverted once again to its original position and optional handles are tied to close the bag.

### RELATED APPLICATION

The present invention claims priority from U.S. Provisional Patent Application Ser. No. 61/491,011 filed May 27, 2011, and is incorporated herein by reference in its entirety for all purposes as if fully set forth herein.

### BACKGROUND OF THE INVENTION

1. Field of the Invention

The invention generally relates to a device used for picking up and disposing of animal waste, and more particularly, to a biodegradable pet waste collection device.

2. Discussion of the Related Art

Pet owners are responsible for the actions of their pets. In many municipalities, it is required by law that pet owners must clean up defecation left by his or her pet if the defecation does not occur on the owner's property. Many pet owners do not pick up the waste due to current products being crudely designed or cumbersome to carry. Also, many of the current devices require the owner to come into direct tactile contact with the waste.

For example, a common method currently used in the removal of pet waste is a common plastic bag. The owner reaches into the bag, picks up the waste while using the bag to shield his or her hand, and then inverts the bag to dispose of the waste into a waste receptacle. Pet owners often find this method unpleasant and therefore do not pick up the waste, leaving the area unsanitary.

In addition, the use of plastic bags is not good for the environment since they can take up to 1,000 years to decompose in the landfills. In addition, the bags often end up in the storm sewer systems causing them to be clogged or overrun with bags.

Other conventional methods include the use of a large device, e.g., a long pole with a scoop attached to the end. The owner uses the scoop to pick up the waste until they are able to dispose of it properly. These products are cumbersome and awkward to carry on a walk and are therefore undesirable.

There is a need for an apparatus or device that allows the convenient features of a plastic bag but also has the ability to dispose of the waste easily.

### SUMMARY OF THE INVENTION

Accordingly, the invention is directed to a biodegradable pet waste collection device that substantially obviates one or more of the problems due to limitations and disadvantages of the related art.

An advantage of the invention is to provide an inexpensive product that is convenient to operate and carry.

Another advantage of the invention is to provide a biodegradable bag and collection aid (or aids) that are convenient for carrying pet waste to a waste receptacle.

Yet another advantage of the invention is to protect the user while picking up waste.

Additional features and advantages of the invention will be set forth in the description which follows, and in part will be apparent from the description, or may be learned by practice of the invention. The objectives and oilier advantages of the invention will be realized and attained by the structure particularly pointed out in the written description and claims hereof as well as the appended drawings.

To achieve these and other advantages and in accordance with the purpose of the present invention, as embodied and broadly described, the invention includes various assortments of collection aids.

In another aspect of the present invention, the collection aids are attached to the bag and perforated to allow easy removal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a pet waste collection device according to an embodiment of the invention;

FIG. 2 illustrates a collection aid according to another embodiment of the invention;

FIG. 3 illustrates a collection aid according to another embodiment of the invention;

FIG. 4 illustrates a pocket to hold the collection aid according to another embodiment of the invention;

FIG. 5 illustrates a collection aid according to another embodiment of the invention;

FIG. 6 illustrates a pet waste collection device in use with a second collection aid according to another embodiment of the invention;

FIG. 7 illustrates a pet waste collection device with a second collection aid after use, according to another embodiment of the invention;

FIG. 8 illustrates a collection aid with a perforation, to allow easy detachment, above a base strip, according to another embodiment of the invention;

FIG. 9 illustrates a collection aid according to another embodiment of the invention;

FIG. 10 illustrates a collection aid in which there are a plurality of slots to allow sifting of waste from sand or cat litter, to according to another embodiment of the invention; and

FIG. 11 illustrates a pet waste collection device according to another embodiment of the invention.

### DETAILED DESCRIPTION OF THE ILLUSTRATED EMBODIMENTS

Aspects of the invention are directed towards an apparatus used to aid in the removal of pet waste left behind by animals. However, the apparatus can also be used to pick up any unwanted waste such as dead rodents, vomit, and the like.

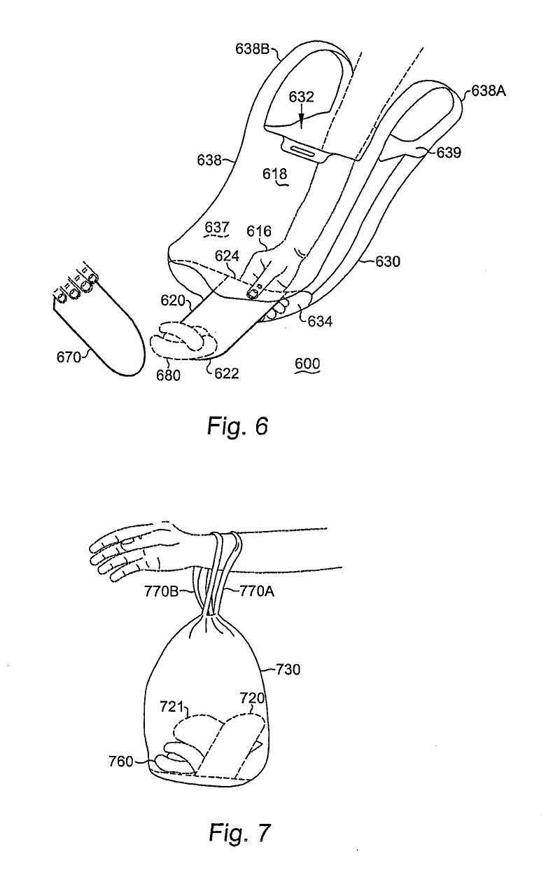

In one embodiment of the invention, the apparatus comprises a bag for collecting the waste. The bag may be made of a waterproof, nonabsorbent polyethylene, a thin flexible plastic, and is similar to bags used in grocery stores for customers to carry out their groceries. The bag is open at one end, with a closed base. In a preferred embodiment the bag is made of biodegradable and/or flushable materials. Alternatively, the bag can be made of other materials for flexibility of choice. The preferred thickness of the bag is 1.5 mil. The bag is preferably rectangular with gusseted sides but alternatively can be of other shapes. The bag is preferably colored to hide the pet waste and make it more discreet once it is inside the bag. The preferred size for the bag is 8″×5″×16″. The bag can also be produced with handles, such as a pair of strip loops as shown in FIG. 6, or with other forms of handles, such as cords, or sides extended in length relative to the bag's face (i.e. “cat's ears” shape). The surfaces of the bag may be smoothed or roughened, or alternate in texture, to facilitate the collection and retention of the waste. The bag can also be fragranced with a scent, e.g. lavender, floral, or potpourri.

In another embodiment of the invention, bags may be stored and dispensed from a container, for example, a box or plastic bag, that has an opening by which to access and grasp the lead bag, allowing the user to pull out one bag at a time. Similarly, bags can be provided either individually or in a roll or sheet form. In another embodiment, bags may be releasably joined at one end along an outer surface; for example, at an open, top end such as with double-handled plastic grocery bags dispensed on supporting stands at supermarket checkout counters or the like.

In another embodiment of the invention, the apparatus comprises a bag as described in the previously mentioned embodiments, and a thin collection aid (CA) for picking up the waste. The CA is sized to fit inside the bag, and is initially attached at its base in the bag's inside corner. The collection aid may be made of paperboard, cardboard, card stock or the same biodegradable or flushable materials as the bag. The CA can also be made of other materials for flexibility of choice. The CA may take the form of a garden trowel to facilitate collecting the pet waste. Such a CA has a flat rectangular base, with a curved leading edge, and a concave face. The CA can also be of alternate shapes. The CA may be attached to the inside corner of the bag, with the attachment either by gluing or other techniques, or combinations of techniques, accepted in the art. The surfaces of the CA may be smoothed or roughened, or a combination of textures, to facilitate the collection and retention of the pet waste in the apparatus. In the embodiment that the bag is made of a biodegradable or flushable material, the collection aid is also made respectively from biodegradable or flushable material, though it may be of a different such material than the bag.

In another embodiment of the invention, a pocket attached to the bag can hold additional collection aids. The pocket can be attached to the bag using glue, heat sealing, spray bond, tape, or any other suitable technique or combination of techniques accepted in the field. The user will be able to take an extra CA out of the pocket to aid in the process of collecting the pet waste. The pocket can be made out of the same material as the bag, but in the embodiments in which the bag is made from a biodegradable or a flushable material, the pocket material also has the respective property. The pocket preferably has the same shape as the CAs it will be housing or can be of alternate shapes. To help overcome any resistance while collecting the waste, the additional CA would be used to help push the waste onto the first CA attached to the bag. The additional CA may be made from the same material as the first CA, or from a different suitable material. In another embodiment, additional CAs are placed inside the invention's packaging to allow the user to have extra collection aids on hand as needed.

For a typical use, the bag is unfolded and the user's hand grasps the base of the CA from the outside of the bag, the bag is then turned inside out so that the collection aid is outside of the bag, with the bag now extending over the user's hand and wrist. The waste is scooped onto the CA, and the end of the bag up the user's arm is then pulled down over the waste and CA back to its original orientation, leaving the waste inside.

In another embodiment of the invention, an extra collection aid is provided, in which this CA is perforated near its rectangular base, just above where this CA is attaches. This perforated CA is attached to the first CA, and are also attached at their joined bases to the bag. Such a perforated CA may have a curved leading edge, but can be of alternate shapes. The end opposite of the leading edge will have a perforation all the way across, allowing the user to easily detach the CA. The perforated CA can be made out of the same material as the first collection aid, or any suitable material. The perforated CA can be affixed to the first, solid, CA with a pressure-sensitive adhesive such as the adhesive used on a sanitary napkin.

In one embodiment of the invention, the entire apparatus is dimensioned and configured to be folded to fit easily in the front pocket, back pocket, wallet, or purse of the user for easy carrying.

Reference is now be made in detail to an embodiment of the present invention, an example of which is illustrated in the accompanying drawings.

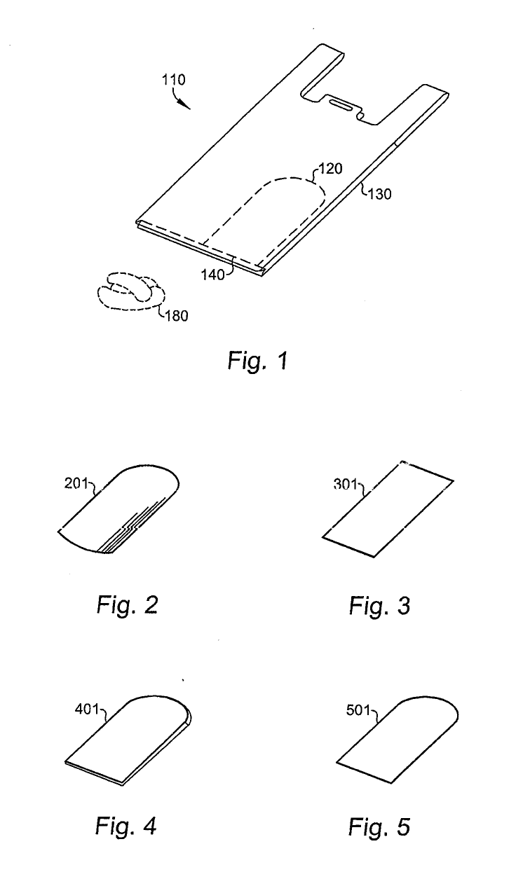

FIG. 1 illustrates a pet waste collection device according to an embodiment of the invention. Referring to FIG. 1, the apparatus is generally depicted as reference number 110. The apparatus 110 includes a bag 130 and a CA 120 attached to an inside corner of the bag 130. The bag 130 may be sealed by a heat sealing process. For example, the heat sealing process includes applying pressure while simultaneously heating the film to a pre-determined temperature to ensure a proper seal. CA 120 is attached to the inside corner of bag 130 such that bag 130 is configured to be easily foldable. CA 120 is attached to bag 130 by bottom edge 140 using appropriate adhesive, glue, spray bond, seaming tape, other suitable techniques or combination of techniques, heat sealing, or another acceptable adhesive in the field. Alternatively, the CA 120 can be mechanically attached to the bag 130 such as by stitching, stapling, deep embossing, or tacking. Both bag 130 and CA 120 can be made from a biodegradable and/or flushable material.

The bag 130 is preferably made of polymeric oxo biodegradable (OBD) plastic, polylactic acid (PLA starch based plastic), or micro-biodegradable plastic, e.g. “Ingeo”™ biopolymer made by NatureWorks LLC, “Encore”™ biodegradable additive made by Command Packaging in California, or “EcoPure” made by Bio-Tec Environmental, LLC in New Mexico. Bag 130 can be flushable, made with flushable paper such as suitable paper used in flushable tissues or toilet paper, water soluble plastic, e.g., polyvinyl alcohol film disclosed in U.S. Pat. No. 2,365,315, cold water soluble plastic foil, e.g., Solvy manufactured by Aqua film, LTD and sold by Sulky of America, or temporary wet strength resins, e.g. Caldas 10 (manufactured in Japan) and CoBond 1000 (manufactured by National Starch and Chemical Company). The thickness of the bag 130 can vary from 0.3 mil to 3.0 mil, however, the preferred thickness is 1.5 mil. Alternatively, the bag 130 can be made out of polymeric, film, laminate, fabric, paper, tissue, foam materials or a waterproof, nonabsorbent polyethylene, a thin flexible plastic, similar to bags used in grocery stores for customers to carry out their groceries.

Bag 130 is preferably rectangular in shape with gusseted sides. Alternatively, it can be square, round, oval, trapezoidal shaped, mitten shaped (having a thumb receiving portion adjacent to a central pouch space), or any other shapes for the particular embodiment of practicing the invention. The bag 130 can be clear, opaque or preferably colored to hide the pet waste 180 and make it a little more discreet once it is inside the bag during transit. Preferably bag 130 may be produced in three sizes to accommodate different size pet waste 180 from various sized animals. The preferred dimensions of the bags are of different sizes, a small bag 6.5″×4″×12″; a medium bag 8″×5″×16″; and a large bag 10″×5″×17″. The bags either may or may not have handles.

The collection aid 120 is rectangular in shape with one end preferably having a curved leading edge to help ease the scooping up the pet waste 180. The CA 120 can be made out of any suitable material including, but not limited to, paperboard, cardboard, card stock, pressed paper, stiff plastic, or foam. The CA is preferably sized respective to the bag with which it will be attached, three sizes being small 3″×4″, medium 4″×5.75″, and large 5″×6.5″. The surface of the CA 120 may be smoothed or roughened, or a combination of textures, to facilitate the collection and retention of the pet waste 180 on the apparatus.

Bags may be provided in a box or bag that has an opening by which to access and grasp the lead bag, allowing the user to pull out one bag at a time. The device can then be placed in a pocket, purse, or wallet for easy transportation before use. Similarly, bags can be provided either individually or in a roll or sheet form. In another embodiment (not illustrated), bags may be releasably joined at one end along an outer surface; for example, at an open, top end such as with double-handled plastic grocery bags disposed on supporting stands at supermarket checkout counters or the like. A modified type of dispenser can be enclosed in a metal case and placed throughout the community in parks, apartment complexes, hotels, residential subdivisions, etc. where bags can be dispensed out one at a time for individuals to use to help keep the community clean of pet waste 180. The small hole placed in the center top portion of the bag assists in supporting and helping to release the bags from the dispenser. Small holes 1101 may also be placed in the top part on the handles, as shown in FIG. 11, to assist in supporting and helping to release the bags from the dispenser.

FIG. 2 illustrates a collection aid according to another embodiment of the invention. The concave CA 201 can be used to facilitate scooping up the pet waste. The concave CA 201 has a rectangular base with a curved leading edge while also being curved downward, similar in shape to the concave shape of a garden trowel. The rectangular base of concave CA 201 is attached to the inside corner of the bag. CA 201 can be attached using a heat sealing process, gluing, spray bond, seaming tape, stitching, deep embossing, stapling, stitching, or any other suitable technique or combination of techniques acceptable in the field. The CA 201 can be made out of any suitable material including, but not limited to, paperboard, cardboard, card stock, pressed paper, stiff plastic, or foam. The surface of CA 201 may be smoothed or roughened, or a combination of textures, to facilitate the collection and retention of the pet waste.

FIG. 3 illustrates a collection aid according to another embodiment of the invention. The CA 301 is completely rectangular in shape. The bottom edge of CA 301 is attached to an inside corner of the bag. CA 301 can be so attached using a heat sealing process, gluing, spray bond, seaming tape, stitching, deep embossing, stapling, stitching, or any other suitable technique or combination of techniques acceptable in the field. CA 301 can be made out of any suitable material including, but not limited to, paperboard, cardboard, card stock, pressed paper, stiff plastic, or foam. The surface of CA 301 may be smoothed or roughened to facilitate the collection and retention of the pet waste on the apparatus.

FIG. 4 illustrates a pocket to hold one or more collection aids, according to another embodiment of the invention. Pocket 401 is attached to the bag, either on the inside or the outside. Alternatively, the pocket 401 can be attached to the bag using glue, spray bond, tape, or any other suitable technique or combination of techniques accepted in the field. Pocket 401 can hold additional collection aids. The user will be able to take extra collection aids out of the pocket 401 to help aid them in the process of scooping up the pet waste. Pocket 401 can be made out of the same material as the bag, and has the same shape as the collection aid it will be housing. Alternatively, the pocket 401 can have a rectangular or square shape. In the embodiments in which the bag is biodegradable and/or flushable, the pocket also has that respective property.

FIG. 5 illustrates a collection aid according to another embodiment of the invention. The additional collection aid 501 would be placed inside a pocket 401. The additional CA 501 can be made out of any suitable material including, but not limited to, paperboard, cardboard, card stock, pressed paper, stiff plastic, or foam

FIG. 6 illustrates an embodiment of the invention in which a perforated, second, collection aid has been detached for use. The device 600 comprises a bag 630 and a first; CA 620 attached to the bag 630. Bag 630 has an open top end 632, a closed bottom end 634, an internal chamber 637, an outer surface 638, and an inner surface 639. Bag 630 has a closed bottom end 634 sized to attach a CA 620 to the inside corner of the internal chamber 637 while being able to fold the bag 630 in half over the CA 620 and then folded in half again in the opposite direction to cover the CA 620 again. CA 620 has a leading edge 622 and a rear edge 624. The device can then be placed in a pocket, purse, or wallet for easy transportation before use.

The bag 630 comprises a closure in the form of handles which consists of a pair of handles 638A and 638B. The handles 638A and 638B provide a convenient mode of transportation to a waste receptacle once there is pet waste in the internal chamber 637. Alternatively, the bag 630 can be made without the handles 638A and 638B.

The user typically grasps the closed bottom end 634 of the bag 630 while also grabbing the rear edge 624 of the CA 620. The bag 630 is then inverted over the user's hand 616, wrist, and forearm 618, to provide protection from the pet waste 680, and exposing the CA 620 and perforated CA 670. At this time, the user may either detach the perforated CA 670 at the perforation or leave it affixed to the first CA 620. The user lightly depresses the leading edge 622 of the CA 620 slightly in front of the pet waste 680, glides the CA 620 under and scoops up the pet waste 680. If there is any resistance from the pet waste 680, the user may use the detached perforated CA 670 to help push the pet waste 680 onto the CA 620. The bag 630 is then inverted back to its original position and the perforated CA 670 can be placed inside the internal chamber 637 along with the pet waste 680. The handles 638A and 638B are then tied together to close the bag 630.

FIG. 7 illustrates what one embodiment of the apparatus looks like after use, with pet waste 760, CA 720, and perforated CA 721 inside the bag during transport. The handles 770A and 770B have been tied together to close the bag 730 and, in this embodiment, the handles 770A and 770B have been realigned to form an opening which allows the user to place his or her hand through and easily carry the device to a waste receptacle.

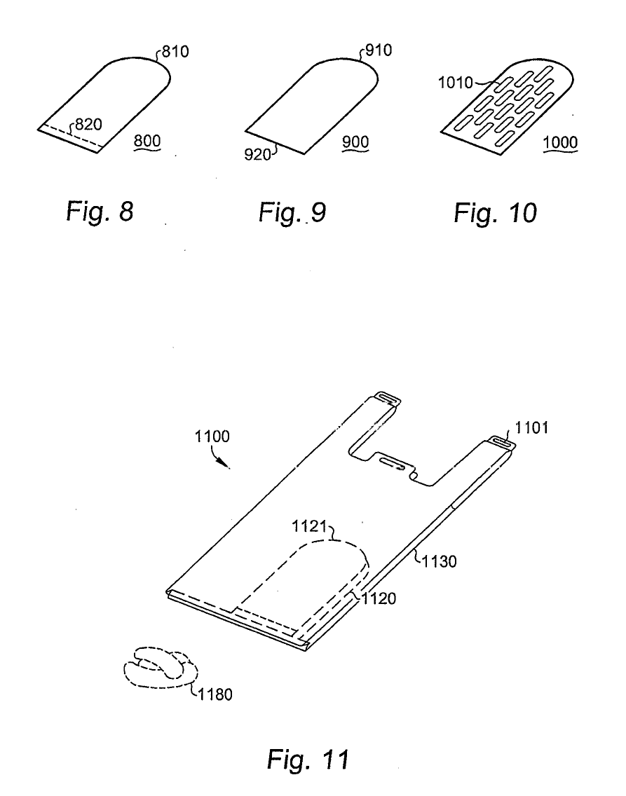

FIG. 8 illustrates a perforated collection aid according to another embodiment of the invention. Preferably, the bottom edge of a perforated CA 800 is attached to the inside corner of the bag. The perforated CA 800 may have a rectangular base with a curved leading edge 810. The base end has a perforation 820 across the entire CA, allowing the user to easily remove the CA to aid in the scooping of the pet waste onto the CA 800. The perforated CA can be made out of any suitable material including, but not limited to, paperboard, cardboard, card stock, pressed paper, stiff plastic, or foam.

In an another embodiment, the lower portion of the perforated collection aid 800, from the base edge to the perforation 820, is permanently attached to a solid CA, which itself is attached to the inside corner of the bag. The preferred permanent attachment is with glue, though the base of the perforated CA 800 can be attached to the solid CA using the heat sealing process, spray bond, seaming tape, stitching, deep embossing, stapling, stitching, or any other suitable technique or combination of techniques acceptable in the field. Next, the top portion of the perforated CA 800, anywhere from the perforation 820 to the leading edge 810, can be affixed to the solid CA with a pressure-sensitive adhesive such as the adhesive used on a sanitary napkin, allowing them to either remain together as one piece or for the perforated CA to be easily detached for use. In operation, perforated CA 800 can either be kept attached to the solid CA as one reinforced CA for picking up waste with a reinforced leading edge 810, or else the perforated CA 800 can be detached from the solid CA at the perforation 820. The surfaces of the perforated CA 800 may be smoothed or roughened, or a combination of textures, to facilitate the collection and retention of the pet waste on the apparatus.

FIG. 9 illustrates a collection aid according to another embodiment of the invention. Preferably, a solid CA 900 is attached to the inside corner of the bag. The CA has a rectangular base with a curved leading edge 910. The base end 920 is attached to the inside corner of the bag and is the portion of the scoop the user grasps to collect the waste. The solid CA can be made out of any suitable material including, but not limited to, paperboard, cardboard, card stock, pressed paper, stiff plastic, or foam. The surface of the solid CA 900 may be smoothed or roughened, or a combination of textures, to facilitate the collection and retention of the pet waste on the apparatus.

FIG. 10 illustrates a collection aid according to another embodiment of the invention. In this embodiment the CA 1000 has a plurality of holes 1010 throughout its facial surface and so could be used for removing cat waste from a litter box while leaving the cat litter behind. The holes 1010 should be just large enough to only pass particles through that the user would not want to dispose of with the cat waste. The bottom edge of CA 1000 would be attached to the inside corner of the bag, preferably by glue, though CA 1000 can be attached using a heat sealing process, spray bond, seaming tape, stitching, deep embossing, stapling, stitching, or any other suitable technique or combination of techniques acceptable in the field. The shape of CA 1000 can be as described in previous embodiments.

The user would scoop the cat waste onto CA 1000 and shake it gently back and forth causing the litter to fall through the holes, back into the litter box. The CA 1000 can be made out of any suitable material including, but not limited to, paperboard, cardboard, card stock, pressed paper, stiff plastic, or foam. The surface of CA 1000 may be smoothed or roughened, or a combination of textures, to facilitate the collection and retention of the pet waste on the apparatus.

FIG. 11 illustrates a pet waste collection device according to another embodiment of the invention. The apparatus 1100 includes a bag 1130 and a collection aid 1120, which is attached along its base to an inside corner of the bag 1130. The bag is sealed at its base either by a heat sealing process, or by another method accepted in the field. For example, one such heat sealing process includes applying pressure while simultaneously heating the film to a pre-determined temperature to ensure a proper seal. The bottom edge of CA 1120 is attached to the inside corner of the bag 1130 using appropriate adhesive, glue, spray bond, seaming tape, other suitable techniques or combination of techniques, heat sealing, or another adhesive process acceptable in the field. Both the bag 1130 and CA 1120 can be biodegradable.

Additionally, a perforated CA 1121 is glued to the inside corner of the bag directly on top of the solid CA 1120. The lower portion of the perforated CA 1121, from the rear edge to the perforation, is permanently affixed to the solid CA with glue to keep them from separating. Solid CA 1120 and perforated CA 1121 are affixed with a pressure-sensitive adhesive such as the adhesive used on a sanitary napkin. The adhesive allows the user to either keep the solid CA 1120 and perforated CA 1121 together without them separating while using the apparatus or gives them the option of removing the perforated CA 1121 for use. Alternatively, the perforated CA 1121 and the solid CA 1120 can be attached using the heat sealing process, spray bond, seaming tape, stitching, deep embossing, stapling, stitching, or any other suitable technique or combination of techniques acceptable in the field. In operation, perforated CA 1120 can be used together with the affixed solid CA 1121 as one reinforced CA picking up waste with a reinforced leading edge. Alternatively, perforated CA 1121 can be detached from the solid CA 1120 via the perforation.

The bag 1130 is preferably made of polymeric oxo biodegradable (OBD) plastic, polylactic acid (PLA starch based plastic), or micro-biodegradable plastic. For example “Ingeo”™ biopolymer made by NatureWorks LLC, “Encore”™ biodegradable additive made by Command Packaging in California, and “EcoPure” made by Bio-Tec Environmental, LLC in New Mexico. The thickness of the bag 1130 can vary from 0.3 mil to 3.0 mil; however, the preferred thickness is 1.5 mil. Alternatively, the bag 1130 can be made out of polymeric materials, material, film, laminate, fabric, paper, tissue, foam, or a waterproof, nonabsorbent polyethylene, a thin flexible plastic, similar to bags used in grocery stores.

Bag 1130 is rectangular in shape with gusseted sides. Alternatively, it can be square, round, oval, trapezoidal shaped, mitten shaped (having a thumb receiving portion adjacent to a central pouch space), or any other shapes for the particular embodiment of practicing the invention. The bag 1130 can be clear, opaque, or preferably colored to hide the pet waste 1180 and make it a little more discreet once it is placed inside the bag during transit. Preferably, bag 1130 may be produced in three sizes to accommodate different size pet waste 1180 from various sized animals. In an embodiment for bags with handles, the preferred dimensions of the bags are: small 6.5″×4″×12″; medium 8″×5″×16″; and large 10″×5″×17″; with these dimensions including the handles. In an alternate embodiment for bags without handles, the bags' preferred sizes are: small 6.5″×4″×8″; medium 8″×5″×11.5″; and large 10″×5″×13″.

The solid collection aid 1120 is rectangular in shape with one end having a curved leading edge to help with the ease of scooping up the pet waste 1180. The solid CA 1120 can be made out of any suitable material including, but not limited to, paperboard, cardboard, card stock, pressed paper, stiff plastic, or foam. The solid CA 1120 may be produced in three sizes relative to the bag ranging from small 3″×4″, medium 4″×5.75″, and large 5″×6.5″. The surface may be roughened to facilitate the retention of the pet waste 1180 on the solid CA 1120. The surfaces may be smooth, rough, or a combination thereof, to facilitate scooping the pet waste 1180 on the solid CA 1120.

Bags may be provided in a box or bag that have an opening by which to access and grasp the lead bag, allowing the user to pull out one bag at a time. The device can then be placed in a pocket, purse, or wallet for easy transportation before use. Similarly, bags can be provided either individually or in a roll or sheet form. In another embodiment, bags may be releasably joined at one end along an outer surface; for example, at an open, top end such as with double-handled plastic grocery bags disposed on supporting stands at supermarket checkout counters or the like. A modified type of dispenser can be enclosed in a metal case and placed throughout the community in parks, apartment complexes, hotels, residential subdivisions, etc. where bags can be dispensed out one at a time for individuals to use to help keep the community clean of pet waste 1180. The small holes 1101 placed in the center top portion of the bag and in the top of each handle assist in supporting and helping to release the bags from the dispenser.

Another embodiment of the invention is a pet waste collection kit comprising a bag having an unsealed top and a closed base end, a collection aid attached to the inside corner of the closed end of the bag, and tissues and/or other sanitary items.

Another embodiment of the invention is directed towards a method for collecting and disposing pet waste that uses a biodegradable bag and built-in disposable collection aids. The user first grasps the lower closed end of the bag while also grabbing the built-in disposable collection aid (CA). The bag is then inverted over the user's hand and forearm, thus providing protection from the pet waste and also exposing the internally attached CA. The leading edge of the CA acts as a scoop and facilitates the collecting of the pet waste. The bag is then inverted once again to its original position, and the bag is closed. Methods of closing the bag may include handles that are part of the bag, which are tied to close the bag. Such handles can be, but are not limited to, loop handles, which further provide a convenient method of transportation to a waste receptacle.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A pet waste collection, comprising:
a bag having an open end and a closed end; and
a first collection aid (CAs) attached to an inside corner of the closed end of the bag, and a second CA included atop the first CA, and wherein the collection aids are dimensioned to fit inside the bag.

2. The apparatus of claim 1, wherein the bag and CAs are made from biodegradable materials.

3. The apparatus of claim 1, wherein the bag and the CAs are made from flushable materials.

4. The apparatus of claim 3, wherein the flushable bag comprises Caldas 10, and CoBond 1000, or Solvy materials, and the CAs are made from a flushable material.

5. The apparatus of claim 1, wherein the collection aids comprise paperboard, cardboard, card stock, stiff plastic, or pressed paper.

6. The apparatus of claim 2, wherein the bag comprises oxo biodegradable plastic, polylactic acid, or micro-biodegradable plastic materials, and the CAs are made from a biodegradable material.

7. The apparatus of claim 1, wherein the second collection aid (CA) comprises a perforation configured to allow detachment of the second CA from the bag.

8. The apparatus of claim 1, wherein the first and second CAs have substantially identical dimensions.

9. The apparatus of claim 1, wherein the bag has a first handle and a second handle.

10. The apparatus of claim 1, wherein the bag comprises a fragrance.

11. The apparatus of claim 10, wherein the fragrance is a lavender, floral, or potpourri scent.

12. The apparatus of claim 1, wherein the bag includes an attached pocket configured to hold one or more CAs.

13. The apparatus of claim 1, wherein the CAs comprise a concave surface.

14. The apparatus of claim 9, wherein dimensions of the bag are substantially 6.5″×4″×12″, 8″×5″×16″, or 10″×5″×17″.

15. The apparatus of claim 1, wherein dimensions of the bag are substantially 6.5″×4″×8″, 8″×5″×11.5″, or 10″×5″×13″.

16. The apparatus of claim 1, wherein dimensions of the CAs are substantially 3″×4″, 4″×5.75″, or 5″×6.5″.

17. The apparatus of claim 1, wherein the CAs are attached to the bag.

18. The apparatus of claim 17, wherein the CAs are attached to the bag with adhesive, heat sealing or glue.

19. The apparatus of claim 17, wherein the CAs are attached to the bag with biodegradable threads.

20. A pet waste collection apparatus for disposal of pet waste, comprising:
a biodegradable bag having an open end and a closed end; and
a collection aid attached to the inside corner of the closed end of the bag, wherein the collection aid is dimensioned to fit solely inside bag and is made of a biodegradable material.

21. The apparatus of claim 20, wherein the collection aid comprises paperboard, cardboard, card stock, or pressed paper.

22. The apparatus of claim 20, wherein the bag comprises oxo biodegradable plastic, polylactic acid, or micro-biodegradable plastic materials.

23. The apparatus of claim 20, further comprising a second CA, made of biodegradable material, included in the closed end of the bag and dimensioned to fit solely inside the bag.

24. The apparatus of claim 23, wherein the second CA comprises a perforation configured to allow release of the second collection aid from the bag.

25. The apparatus of claim 23, wherein the CAs have substantially identical dimensions.

26. The apparatus of claim 20, wherein the bag has a first handle and a second handle.

27. The apparatus of claim 20, wherein the bag comprises a fragrance.

28. The apparatus of claim 20, wherein the bag comprises a pocket configured to hold one or more CAs.

29. The apparatus of claim 20, wherein the CA comprises a concave surface.

30. The apparatus of claim 20, wherein the CA is attached to the bag with adhesive, heat sealing or glue.

31. The apparatus of claim 20, wherein the CA is attached to the bag with biodegradable threads.

32. A pet waste collection apparatus for disposal of pet waste, comprising:
a bag having an open end and a closed end; and
a collection aid, with a perforation configured for detachment, attached to the inside corner of the closed end of the bag, wherein the collection aid is dimensioned to fit solely inside the bag.

33. The apparatus of claim 32, further comprising a second CA included in the closed end of the bag, wherein the second CA is dimensioned to fit solely inside the bag.

34. The apparatus of claim 33, wherein the second CA is temporarily attached to the first CA.

35. The apparatus of claim 34, wherein the second collection aid is temporarily attached to the first CA using a pressure sensitive adhesive.

36. The apparatus of claim 33, wherein the second CA is attached to the first CA on a top portion with a pressure sensitive adhesive wherein the attachment is temporary, and on a bottom portion where the attachment is permanent.

37. The apparatus of claim 32, wherein the bag is biodegradable, and the collection aid is made from a biodegradable material.

38. A pet waste collection apparatus for disposal of pet waste, comprising:
a biodegradable bag having an open end and a closed end;
a first CA attached to an inside corner of the closed end of the bag and which is dimensioned to fit solely inside the bag; and
a second CA, with a perforation configured for detachment, attached to the first CA and the second CA is dimensioned to fit solely inside bag.

39. A container storing and dispensing the pet waste collection apparatus of claim 38.

40. A method of collecting pet waste, comprising:
grasping a lower closed end of a bag and a disposable CA built-in to the bag;
inverting the bag over a user's hand;
scooping the pet waste with the disposable CA; and
inverting the bag to its original position.

41. The method of collecting pet waste of claim 40, wherein scooping the pet waste with the disposable CA further comprises pushing the pet waste on to the disposable CA with a second CA.

42. The method of collecting pet waste of claim 41, wherein the second CA is built-in to the bag and has a perforation configured to allow detachment of the second CA from the bag.

43. The method of collecting pet waste of claim 40, wherein the bag and all CAs are is biodegradable.

44. A pet waste collection apparatus for disposal of pet waste, comprising:
a bag having an open end and a closed end; and
a CA attached to the inside corner of the closed end of the bag and the CA is dimensioned to fit inside the bag.

45. A pet waste collection kit for disposal of pet waste, comprising:
a bag having an open end and a closed end;
a CA attached to the inside corner of the closed end of the bag and the CA is dimensioned to fit inside the hag; and
tissues.

46. The pet waste collection kit of claim 45, wherein the bag and the CA is are each made from biodegradable materials.

47. The pet waste collection kit of claim 45, further comprising a second CA attached to the closed end of the bag, wherein the second CA is dimensioned to fit inside the bag.

48. The pet waste collection kit of claim 47, wherein the second CA has a perforation configured for detachment.

49. The pet waste collection apparatus of claim 38, wherein the bag comprises handles having holes in a top of each handles.

50. A dispenser for the pet waste collection apparatus of claim 49, wherein the dispenser holds a plurality of bags through the holes.
